(19) United States
(12) Patent Application Publication
(10) Pub. No.: US 2013/0227447 A1
(43) Pub. Date: Aug. 29, 2013

(54) TERMINAL AND METHOD FOR PROVIDING DYNAMIC USER INTERFACE INFORMATION THROUGH USER INPUT CORRECTION FUNCTION

(71) Applicant: Pantech Co., Ltd., (US)

(72) Inventor: Bo Gon Jun, Seoul (KR)

(73) Assignee: Pantech Co., Ltd., Seoul (KR)

(21) Appl. No.: 13/735,522

(22) Filed: Jan. 7, 2013

(30) Foreign Application Priority Data
Feb. 29, 2012 (KR) 10-2012-0021116

(51) Int. Cl. G06F 3/01

(52) U.S. Cl. CPC G06F 3/01
USPC 715/762

(57) ABSTRACT

A terminal and a method for providing user input correction of dynamic user interface information, with a user input correction function, including displaying a dynamic user interface including at least one user interface (UI) information item; determining whether the dynamic user interface is updated; where the dynamic user interface is updated, storing the dynamic user interface information for the at least one UI information item before and after occurrence of the update of the UI information for the UI information item in a storage unit; determining whether there is user input to select a UI information item from the dynamic user interface after the update; and where there is the user input, displaying at least one piece of UI information corresponding to the at least one UI information item from the stored dynamic user interface information before and after occurrence of the UI information update.

### CROSS-REFERENCE TO RELATED APPLICATIONS

This application claims priority to and the benefits under 35 U.S.C. §119 of Korean Patent Application No. 10-2012-0021116, filed on Feb. 29, 2012, the contents of which are herein incorporated in its entirety by reference for all purposes as if fully set forth herein.

### BACKGROUND

1. Field

Exemplary embodiments relate to apparatuses and methods for providing dynamic user interface information for a terminal with a user input correction function.

2. Discussion of the Background

Recently, as terminals, such as smartphones, increase in use, efforts have been made to enhance the performance of hardware or software utilized by the terminals. In particular, to efficiently provide a user interface (UI) in a terminal is an important consideration. In a case where a UI is actively updated and the updates are provided to a terminal, a user makes a touch input in order to select a specific item for use or viewing. However, in such case, data may be updated before the touch input and different information may be input to the corresponding input point, which may be information a user did not intend to view.

FIG. 1A illustrates a typical state before a user applies a touch input to a terminal, such as with a finger, to select a device 1, for example. In the illustrated example of FIG. 1A, the user searches Bluetooth devices associated with the terminal. And FIG. 1B illustrates a state where a search list of the Bluetooth devices is updated before the user enters a touch input to the device 1. Thus, as illustrated in FIG. 1B, the user enters a touch input to select a device 4 by mistake. Therefore, it is important for a UI, which is actively updated, such as a list or a control widget, to correctly represent or determine an input action of the user. In a case where the UI is actively updated and the user selects a wrong item, as a result of an updating operation, the user typically has to cancel the selection and repeat a selecting operation, which may be inconvenient.

### SUMMARY

Exemplary embodiments of the present invention provide dynamic user interface information for a terminal with a user input correction function and a method for the same.

Additional features of the invention will be set forth in the description which follows, and in part will be apparent from the description, or may be learned by practice of the invention.

Exemplary embodiments relate a terminal to provide user input correction of dynamic user interface information, including: an update determination unit to determine if user interface (UI) information for at least one UI information item is updated; a storage unit to store the UI information for the at least one UI information item; and a control unit to control storing of the UI information for the at least one UI information item in the storage unit before an occurrence of an update of the UI information and after the occurrence of the update of the UI information when it is determined the UI information for the at least one UI information item is updated.

Exemplary embodiments of the invention also relate to a method for providing user input correction of dynamic user interface information in a terminal, including: determining if user interface (UI) information for at least one UI information item is updated; and storing the UI information for the at least one UI information item before an occurrence of an update of the UI information and after the occurrence of the update of the UI information, when it is determined the UI information for the at least one UI information item is updated.

Exemplary embodiments of the invention further relate to a method for providing user input correction of dynamic user interface information in a terminal, including: determining if user interface (UI) information for at least one UI information item is updated; storing the UI information for the at least one UI information item before the occurrence of an update of the UI information and after the occurrence of the update of the UI information when it is determined the UI information for the at least one UI information item is updated; determining if a reference time period measured from a time of the occurrence of the update of the UI information has elapsed; and determining to selectively display the stored UI information for the at least one UI information item based upon the reference time period.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIGS. 1A and 1B are exemplary diagrams illustrating where a user intends to select one item, but selects an incorrect item at a dynamic user interface (UI) in a related terminal.

FIG. 2 is a schematic configuration diagram of a terminal to provide a dynamic user interface according to exemplary embodiments of the present invention.

FIG. 3 is a flowchart illustrating methods for providing dynamic user interface information according to exemplary embodiments of the present invention.

FIG. 4 is a flowchart illustrating operation S160 of FIG. 3, according to exemplary embodiments of the present invention.

FIG. 5 is a conceptual diagram illustrating methods for processing a user input according to exemplary embodiments of the present invention.

FIG. 6 is a conceptual diagram illustrating methods for processing a user input according to exemplary embodiments of the present invention.

FIGS. 7 and 8 are diagrams illustrating a selection pop-up window in a terminal where there is a user input within a reference time period T after an update in apparatus and methods for providing a dynamic user interface according to exemplary embodiments of the present invention.

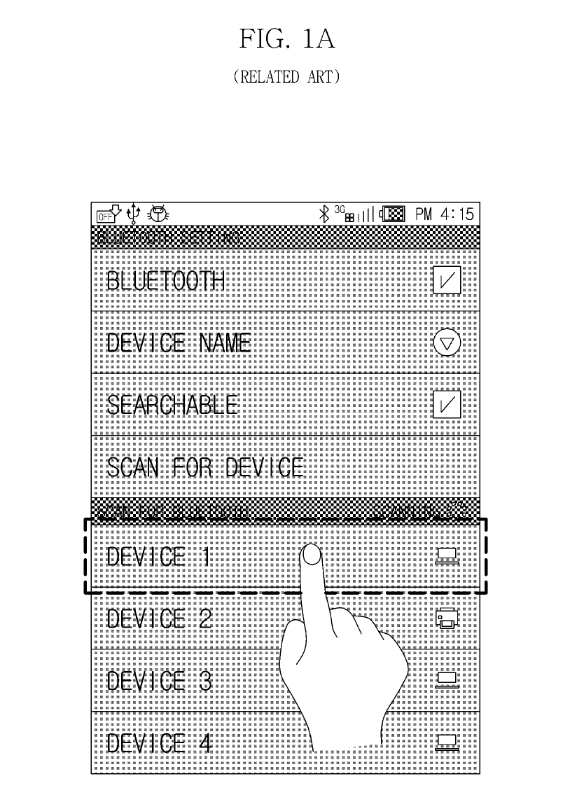

### DETAILED DESCRIPTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element is referred to as being “connected to” another element, it can be directly connected to the other element, or intervening elements may be present; and, as to wireless communication, may be interpreted as being wirelessly connected, such as a wireless connection between a terminal and a base station or external server, for example.

Hereinafter, a terminal may include, for example, a mobile communication terminal, handheld, portable or tablet computer or communication devices, or other apparatuses, and methods for providing dynamic user interface information for a terminal with a user input correction function, will be described in more detail with reference to the drawings, and should not be construed in a limiting sense. Also, the terminal, and the units of the terminal herein described, include hardware and software, and can also include firmware, to perform various functions of the terminal including those in providing dynamic user interface information for a terminal with a user input correction function, including those described herein, as may be known to one of skill in the art. As such, terminal as used herein should not be construed in a limiting sense and may include the above and other apparatuses to provide a dynamic user interface, with a correction input function.

Also, a terminal may include, for example, any of various devices or structures used for wireless or wired communication to provide a dynamic user interface, with an input correction function, and can be wired or wireless connected to a base station, server or network, and may include another terminal, and also may include hardware, firmware, or software to perform various functions for providing dynamic user interface information for a terminal with a user input correction function, including those described herein, as may be known to one of skill in the art.

Hereinafter, a terminal, such as including, for example, a mobile terminal, a mobile communication terminal, handheld, portable or tablet computer or communication devices, or other apparatuses, and methods for providing dynamic user interface information for a terminal with a user input correction function will be described in more detail with reference to the drawings.

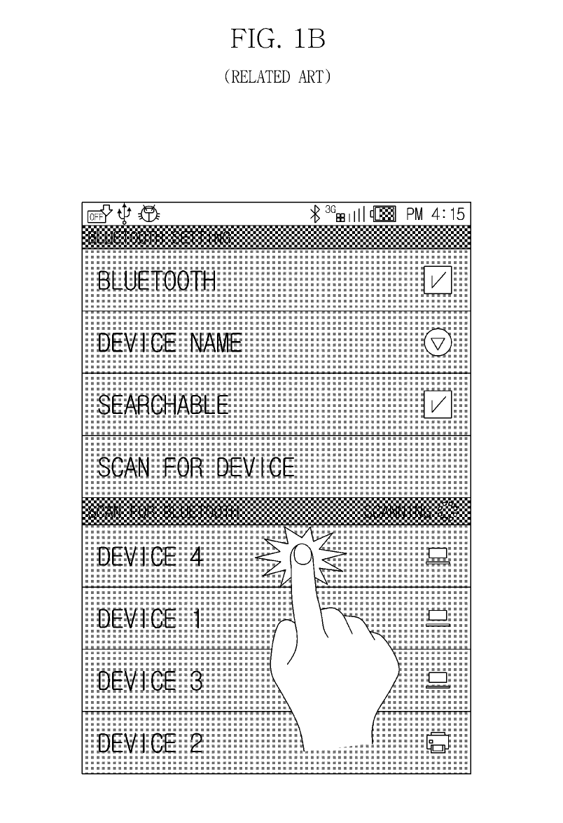

FIG. 2 is a schematic configuration diagram of a terminal to provide a dynamic user interface (UI) according to exemplary embodiments of the present invention.

Referring to FIG. 2, apparatus to provide a dynamic user interface, according to exemplary embodiments may be, for example, a terminal 10. The terminal 10 includes a UI information detection unit 11, an update determination unit 12, a timer unit 13, a storage unit 14, an input unit 15, a display unit 16, and a control unit 17.

The terminal 10, including the UI information detection unit 11, the update determination unit 12, the timer unit 13, the storage unit 14, the input unit 15, the display unit 16, and the control unit 17 are associated with and may include any of various memory or storage media for storing software, program instructions, data files, data structures, and the like, and are associated with and may also include any of various processors, computers or application specific integrated circuits (ASICs) for example, to implement various operations to provide dynamic user interface information for a terminal with a user input correction function, such as terminal 10, as described herein. And although described as separate units, processors, memories, modules or components, aspects are not limited thereto such that each of the units, processors, memories, modules or components may be combined with any one or more units, processors, memories, modules or components, for example, and should therefore should not be construed in a limiting sense.

The software, media and program instructions may be those specially designed and constructed for the purposes of the present invention, or they may be of the kind well-known and available to those having skill in the computer software arts. Examples of program instructions include both machine code, such as produced by a compiler, and files containing higher level code that may be executed by the computer using an interpreter. The described hardware devices may, for example, include hardware, firmware or other modules to perform the operations of the described embodiments of the present invention.

Without being construed in a limiting sense, in addition to the foregoing, the terminal 10 may be a cellular phone, a personal digital assistant (PDA), a wireless communication device, a portable device, a laptop computer, a codeless telephone, or the like. For example, the terminal 10 may be a portable multi-function device, such as a smartphone, a smartpad, or a tablet PC, according to exemplary embodiments.

The input unit 15 of terminal 10 is an interface device that may receive a command of a user and includes, for example, a key input unit, such as a keypad, that generates key data whenever a button is pressed, a touch screen, a motion detection sensor, a breath or mouth detector, or an external input device using inter-device wired/wireless communication, among others, to input information to the terminal 10.

The display unit 16 of terminal 10 is a liquid crystal display device, for example, such as an liquid crystal display (LCD) device, a light-emitting diode (LED) display device, or an organic light-emitting diode (OLED) display device, and displays the status of the terminal 10, or the progress of an application or a program according to a control signal of the control unit 17. In addition, the display unit 16 according to exemplary embodiments displays dynamic user interface (UI) information or a list according to the command of a user input to the input unit 15. Furthermore, the display unit 16 and the input unit 15 may be constructed in combination, such as a touch screen to receive user input to the terminal 10.

The dynamic UI information item, according to exemplary embodiments, may include various forms of user interface (UI) information displayed on the display unit 16 of the terminal 10. And the UI information items may include UI information or a list of UI items dynamically updated with time or with a change in the circumstances, for example. The dynamic UI information may correspond to list information regarding UI items in which objects that are accessible depending on the time or circumstances are dynamically changed, control widget information, or the like, for example. The dynamic UI information and the UI information items are not to be construed as being limited to any particular form, and may have any form as can be displayed on the display unit 16. And dynamic UI information corresponding to one or more UI information items is displayed on the display unit 16 of the terminal 10 so that a user may select, such as by the input unit 15, at least one UI information item from various UI information items displayed on the display unit 16. As an example, as described later in the specification, a list of surrounding Wi-Fi devices searched by the terminal 10 is exemplified as a list of UI information items as can be displayed on the display unit 16 of terminal 10 for selection by a user using the input unit 15, according to exemplary embodiments.

When the user searches a list of Wi-Fi devices, the terminal 10 scans other terminals, such as access points (APs) in a reference range, which may be a pre-set range, that are accessible to the terminal 10, at a scanning time period, which may be a predetermined scanning time period, or according to a refresh command of the user, and displays the scanning result on the display unit 16 of the terminal 10. Therefore, the devices identified by the scanning operation are displayed on the display unit 16, such as in the order of Received Signal Strength Indication (RSSI) value, and the display order may be dynamically updated or changed as the RSSI value is changed for the various devices within the reference range.

The UI information detection unit 11 of the terminal 10 is a detector to detect the dynamic UI information displayed on the display unit 16. That is, the UI information detection unit 11 detects the dynamic UI information that is received by the terminal 10 and is dynamically updated in hardware, as may be implemented by software, in the terminal 10.

The update determination unit 12 of the terminal 10, is a processor to update the dynamic UI information to new dynamic UI update information on the basis of the dynamic UI information detected by the UI information detection unit 11, and also to detect an update time of the changed new UI information and information regarding the updated contents of the detected dynamic UI information.

The timer unit 13 of the terminal 10 is a processor that receives the update time detected by the update determination unit 12 and calculates or determines a time that has elapsed from the update time point detected by the update determination unit 12, as from a time of occurrence of an update of the UI information.

The storage unit 14 of the terminal 10 is a memory or any of various storage media to store the dynamic UI information. According to exemplary embodiments, the storage unit 14 stores the dynamic UI information before and after the update for a reference time period, which may be a predetermined time period, even where the dynamic UI information is updated. The dynamic UI information stored before and after the update may be provided for or to the user according to the control of the control unit 17, as described herein. According to exemplary embodiments, the dynamic UI information stored in the storage unit 14 before the update may be deleted after the reference time period has elapsed.

The control unit 17 is a processor that controls the storing of the dynamic UI information before and after the update in the storage unit 14 where the update of the dynamic UI information is detected by the update determination unit 12. The control unit 17 determines whether a reference time period T, which may be a pre-set time or time period, elapses after the time update point, such as by using the time update point from which to determine whether the reference time period T has elapsed, such as based upon the time determined by timer unit 13. In addition, where there is user input to the terminal 10 before the reference time period T elapses, the control unit 17 controls the display unit 16 to display dynamic user interface information before and after the update stored in the storage unit 14. Also, according to exemplary embodiments, the control unit 17 may delete the UI information before the update from the information stored in the storage unit 14, such as where the reference time period T has elapsed.

According to exemplary embodiments, it is determined, such as on a relatively continuous, a continuous, a periodic, or a non-periodic basis, whether or not there is user input within the reference time period T from the update time point at which the dynamic UI information is updated. And where there is user input within the reference time period T from the update time point, the stored UI information from the storage unit 14 corresponding to the input position of the corresponding UI information item is displayed on the display unit 16 for selection of the user.

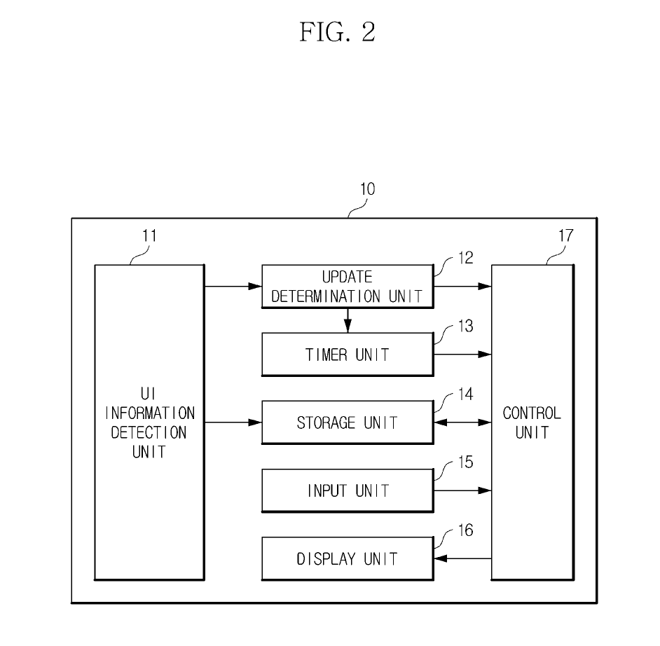

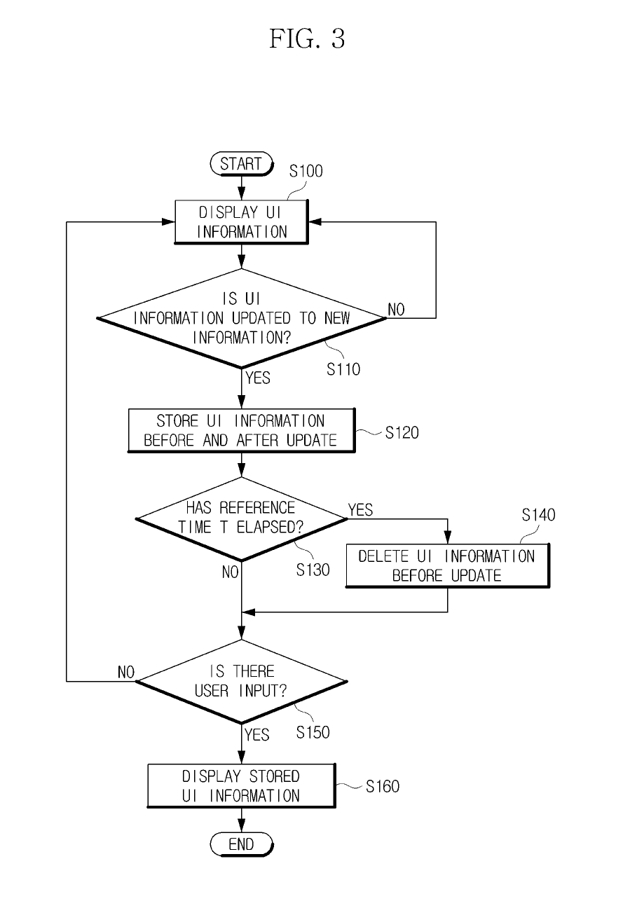

Hereinafter, methods for processing the user input for the dynamic UI of the terminal 10 according to exemplary embodiments will be described in detail with reference to FIG. 3 and FIG. 4.

FIG. 3 is a flowchart illustrating methods for providing dynamic user interface information according to exemplary embodiments of the present invention.

Referring to FIG. 3, the control unit 17 of the terminal 10, according to exemplary embodiments, displays UI information for the UI information items corresponding to a terminal manipulation of the user of terminal 10 on the display unit 16 in operation S100. Herein, the UI information, may be, for example a list of surrounding Bluetooth devices.

Then, the update determination unit 12 detects whether UI information is updated to new updated UI information in operation S110 for the UI information items. Where there is no update of the UI information, the existing state of the UI information is maintained, and the existing UI information may continue to be displayed on the display in operation S100.

Where the UI information is updated to new updated UI information, the control unit 17 stores the UI information before and updated UI information after the update in the storage unit 14 in operation S120. The storage unit 14 stores the UI information for the UI information items detected by the UI information detection unit 11 and continuously, relatively continuously, periodically, or non-periodically updates data for the UI information for the UI information items to be stored while deleting old data as, for example, under control of the control unit 17, such as where a reference condition is satisfied.

Next, the control unit 17 determines whether or not the reference time period T has elapsed, the reference time period being an example of a reference condition, after the update of the UI information for the UI information items by using the information calculated or determined by the timer unit 13 in operation S130. When it is determined that the reference time period T has not elapsed, it is determined whether there is user input to the input unit 15 of the terminal 10, such as to a keypad or a touch screen of the input unit 15, for example, in operation S150.

Where there is user input to the input unit 15, the UI information corresponding to UI information items stored in the storage unit 14 is displayed on the display unit 16 for the user in operation S160. Since the storage unit 14 stores the UI information before and the updated UI information after the update, by displaying all the UI information before and after the update for the user, the user is enabled to confirm the user selection of one or more UI information items again. Thereafter, when the user selects a specific UI information item, an operation according to the selected UI information item may be performed by the terminal 10, according to exemplary embodiments.

As, for example, where there is user input to the input unit 15 of the terminal 10 within the reference time period T from the update time point, the user may have an intention to select UI information data before the update time point. Therefore, the above operations, according to exemplary embodiments, may increase providing correct UI information, such as by a selection pop-up window for the user, in order to minimize or reduce canceling an input and re-selection of a UI information item, for example.

Further, in the operation S150, where it is determined there is no user input, the process returns to operation S100 which is then performed, and the existing UI information is displayed on the display unit 16, and the operations S110, S120, and S130 are again performed.

When it is determined that the reference time period T has elapsed in the operation S130, the control unit 17 may delete the UI information before the update from the UI information stored in the storage unit 17 in operation S140. The operations described with reference to FIG. 3 are performed as time passes, such as in relation to the reference time period T. Thus, the operation S140 is performed where there is no user input within the reference time period T, such as where the reference time period T has elapsed, after the update time point. For example, where there is not received by the terminal 10 user input within the reference time period T after the update time point, there is typically a relatively low probability that the user may make an incorrect selection of the UI information item before the corresponding UI information update.

When the operation S150 is performed after the operation S140, such as where there is user input after the reference time period T has elapsed, the control unit 17 controls the display of the UI information to display the UI information stored in the storage unit 14 on the display unit 16. Here, the control unit 17 controls the storage unit 14 to delete the UI information before a time of the occurrence of the update of the UI information from the storage unit 14 and only the updated UI information after the time of the occurrence of the update of the UI information is stored in the storage unit 14, so that only the updated UI information for the UI information items after the update is displayed on the display unit 16 of the terminal 10.

In the above examples, it is assumed that an error is not made by the user in selecting the UI information item as, for example, the user makes an error to accidentally enter an incorrect input. Therefore, according to exemplary embodiments, where the user makes an intended input to a selected UI information item to the input unit 15 of terminal 10, instead of displaying the UI information corresponding to the UI information item after the update for re-selection of the user on the display unit 16, an operation for the updated UI information, as may include UI information stored before the update, after the update may be selected and may be performed immediately or in a relatively short time period to provide the user with the intended UI information displayed on the display unit 16.

FIG. 4 is a flowchart illustrating operation S160 of FIG. 3, according to exemplary embodiments of the invention.

Referring to FIG. 4, methods for displaying the UI information on the display unit 16 by the control unit 17 will be described according to exemplary embodiments. The flowchart of FIG. 4 illustrates where there is user input within the reference time period T after the UI information update, and information that allows the user to select two or more UI information items is displayed on the display unit 16.

In the operation S150 of FIG. 3, where there is user input to the input unit 15, position information on the user input is detected by the input unit 15 in operation S161. The operation S161 to detect the position information on the user input is for checking or determining which UI information item the user is to select. Where the input unit 15 is constructed with buttons and the like, such as a keypad, the position of a selection area of the input unit 15, such as corresponding to that on the display unit 16, for the selection of the UI information item or items, is detected by the operation of the buttons and the like, for example. On the other hand, where the input unit 15 is constructed with a touchscreen, the position of a touch input point of the user on the touchscreen of the input unit 15, such as corresponding to that on the display unit 16, is detected, to indicate the selected UI information item or UI information items, for example.

When the position information on the user input is detected by the input unit 15, a UI information item corresponding to the position information detected from the UI information stored in the storage unit 14 is extracted in operation S162. And the UI information item or UI information items before and after the update at the position or positions that the user is to select is extracted from the storage unit 14 under control of the control unit 17, according to exemplary embodiments.

When the UI information item is extracted, or the UI information items are extracted, from the storage unit 14, the UI information for the extracted UI information item is displayed on the display unit 16 in operation S163. The display methods, according to exemplary embodiments, may be methods for creating a pop-up window for re-selection of the user, for example.

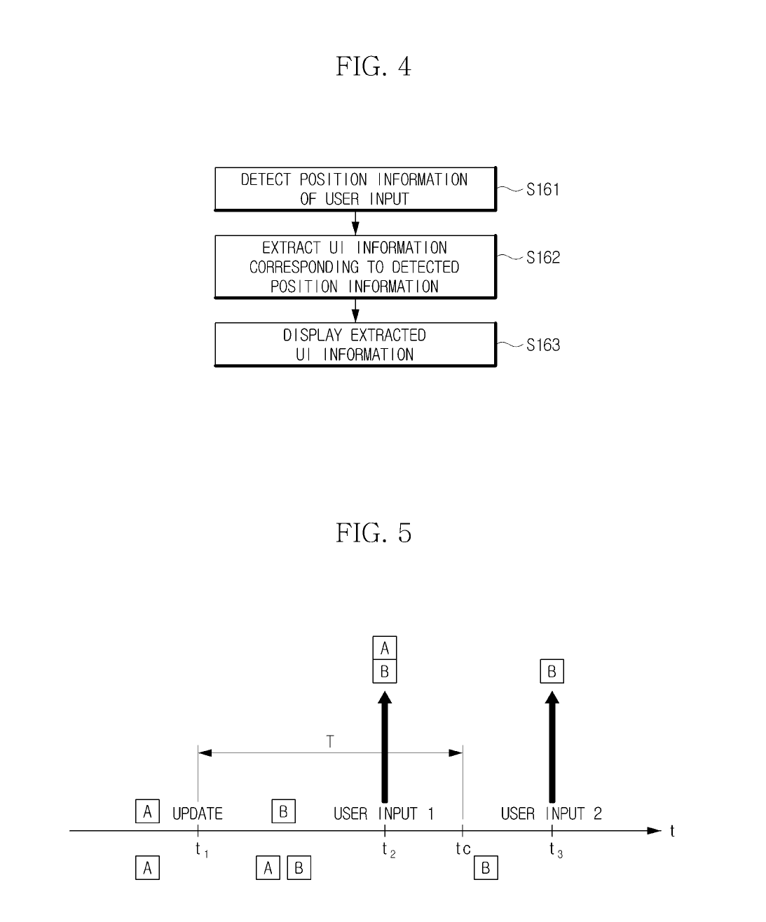

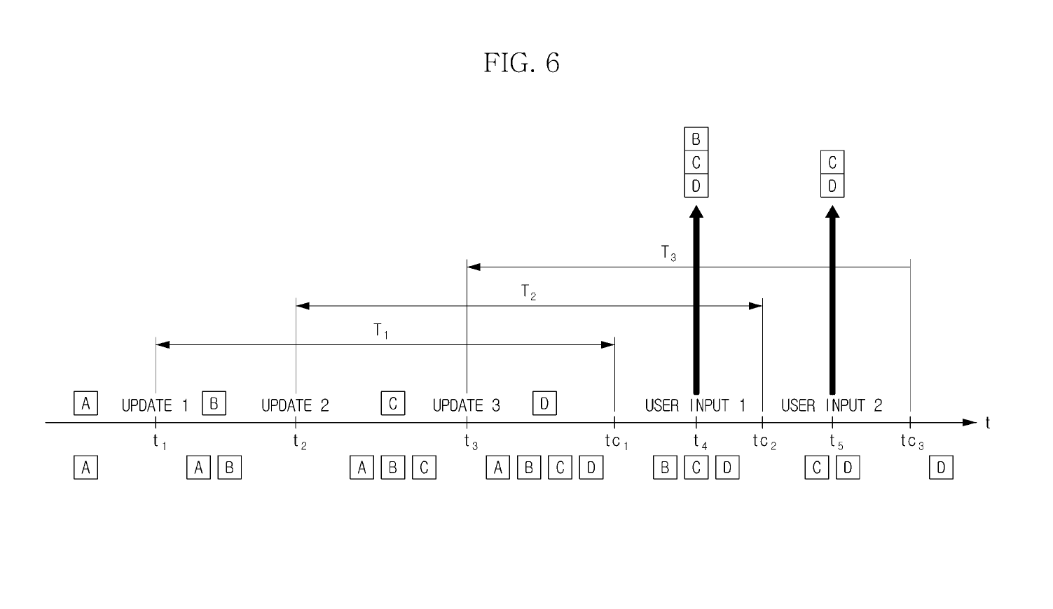

Hereinafter, operations where there is a single update and where there are a plurality of updates will be described with reference to the conceptual diagrams of FIGS. 5 and 6, according to exemplary embodiments.

FIG. 5 is a conceptual diagram illustrating methods for processing a user input where there is a single update for a dynamic UI, according to exemplary embodiments of the present invention.

Referring to FIG. 5, there is an update of UI information for one or more UI information items at a time t₁, a user input 1 occurs at a time t₂, and a user input 2 occurs at a time t₃.

In FIG. 5, A and B respectively correspond to UI information items before and after the update, with UI information items A and B displayed above the time line corresponding to the UI information being changed from UI information item A to UI information item B due to the update, and with UI information items A, AB, and B displayed below the time line corresponding to the UI information for the UI information items stored in the storage unit 14. The exemplary illustration of FIG. 5 is described as follows.

From FIG. 5, it is seen that the UI information is updated from UI information item A to UI information item B at t₁, UI information item A is stored in the storage unit 14 before the update, and UI information items A and B are stored in the storage unit 14 after the update. Within the reference time period T from the update time point t₁, UI information items A and B are stored in the storage unit 14, and after the reference time period T, UI information item A information before the update is deleted from the storage unit 14 and only the UI information item B information is stored in the storage unit 14, for example.

Where there is user input, the control unit 17 displays the UI information stored in the storage unit 14 at the input time point, such as at input time point t₂ or t₃, through the display unit 16. That is, as illustrated in FIG. 5, where there is the user input 1 at time t₂ before the reference time period T has elapsed at time tc, both UI information items A and B are displayed on the display unit 16, such as a pop-up window for selection of the user, for example. And where there is the user input 2, such as at time t₃, after the reference time period T has elapsed, only UI information item B is displayed on the display unit 16 of terminal 10, for example. As mentioned above, where the number of pieces of the stored UI information corresponds to one UI information item, selected operations may be performed immediately or in a relatively short time without an additional selection of a pop-up window by the user of the terminal 10, according to exemplary embodiments.

FIG. 6 is a conceptual diagram illustrating methods for processing a user input where there is a plurality of updates for the dynamic UI according to exemplary embodiments of the present invention.

Although similar to FIG. 5, the example of FIG. 6 illustrates where there is a plurality of updates to the UI information, namely three updates, for example, illustrated in FIG. 6. In the exemplary illustration of FIG. 6, an update 1 occurs at t₁, an update 2 occurs at t₂, an update 3 occurs at t₃, a user input 1 occurs at t₄, and a user input 2 occurs at t₅.

The control unit 17 determines whether or not the reference time period T has elapsed from each update t₁, t₂, and t₃. And where the reference time period T has elapsed from each update t₁, t₂, and t₃, the control unit 17 deletes the UI information for the UI information items before the corresponding update time point from the storage unit 14, according to exemplary embodiments.

In FIG. 6, for convenience, the reference time period T is displayed or illustrated as reference time periods T₁, T₂, and T₃ in the generated order. In the example of FIG. 6, the reference time period T₁ is measured from update 1 at time t₁ to time tc1, the reference time period T₂ is measured from update 2 at time t₂ to time tc2, and the reference time period T₃ is measured from update 3 at time t₃ to time tc3. The reference time periods T₁, T₂, and T₃ are illustrated as being of a same time period in FIG. 6, but the reference time periods T₁, T₂, and T₃ may each be of different time period or time duration, or the reference time period T may change, depending on the use or application, according to exemplary embodiments.

As illustrated in the example of FIG. 6, the UI information is changed from UI information item A to UI information item B due to the update 1, the UI information is changed from UI information item B to UI information item C due to the update 2, and the UI information is changed from UI information item C to UI information item D due to the update 3, and UI information corresponding to UI information items A, AB, ABC, and ABCD are sequentially stored in the storage unit 14, according to exemplary embodiments.

However, after the reference time period T₁ has elapsed from the update 1 at time tc1, UI information item A information which is data before the update 1 is deleted from the storage unit 14, leaving UI information items B, C, and D information stored in the storage unit 14. Similarly, after the reference time period T₂ has elapsed at time tc2 from the update 2, UI information item B information is deleted from the storage unit 14 leaving UI information items C and D information stored in the storage unit 14. And after the reference time period T₃ has elapsed from the update 3 at time tc3, UI information item C information is deleted from the storage unit 14 leaving UI information item D information stored in the storage unit 14. The data for the UI information stored in the storage unit 14 at the corresponding times is displayed on the display unit 16 as indicated at each section below the time line in FIG. 6.

Continuing with reference to the example illustration of FIG. 6, according to exemplary embodiments, where there in user input to the input unit 15 of terminal 10, the UI information stored in the storage unit 14 is displayed on the display unit 16, as follows, for example. Where there is the user input 1 at time t₄, the UI information items B, C and D information stored in the storage unit 14 is displayed on the display unit 16. And where there is the user input 2 at time t₅, the UI information items C and D information stored in the storage unit 14 is displayed on the display unit 16. And after time tc3, the UI information item D information stored in the storage unit 16 is displayed on the display unit 16. The UI information may be displayed on the display unit 16 as a pop-up window for re-selection of the user, according to exemplary embodiments.

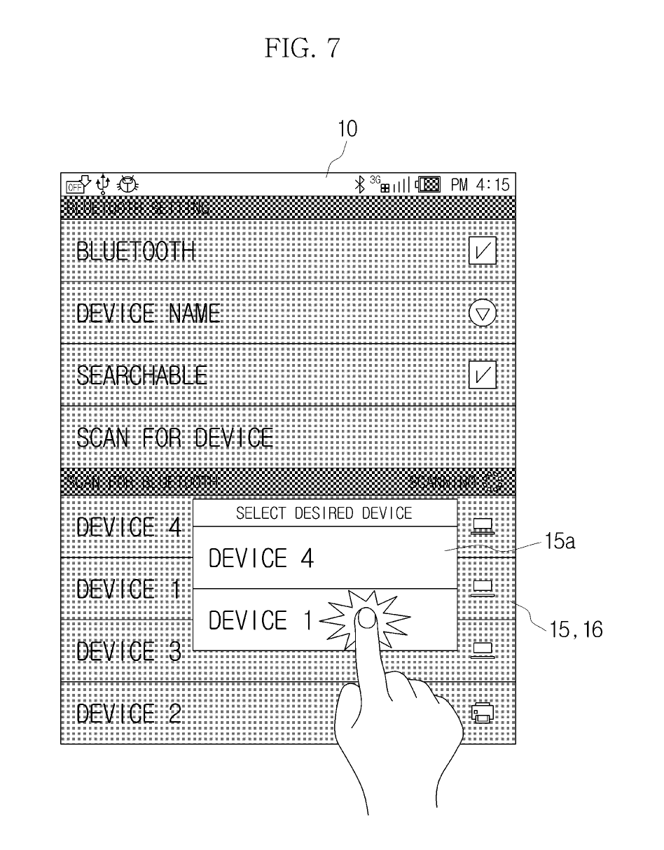

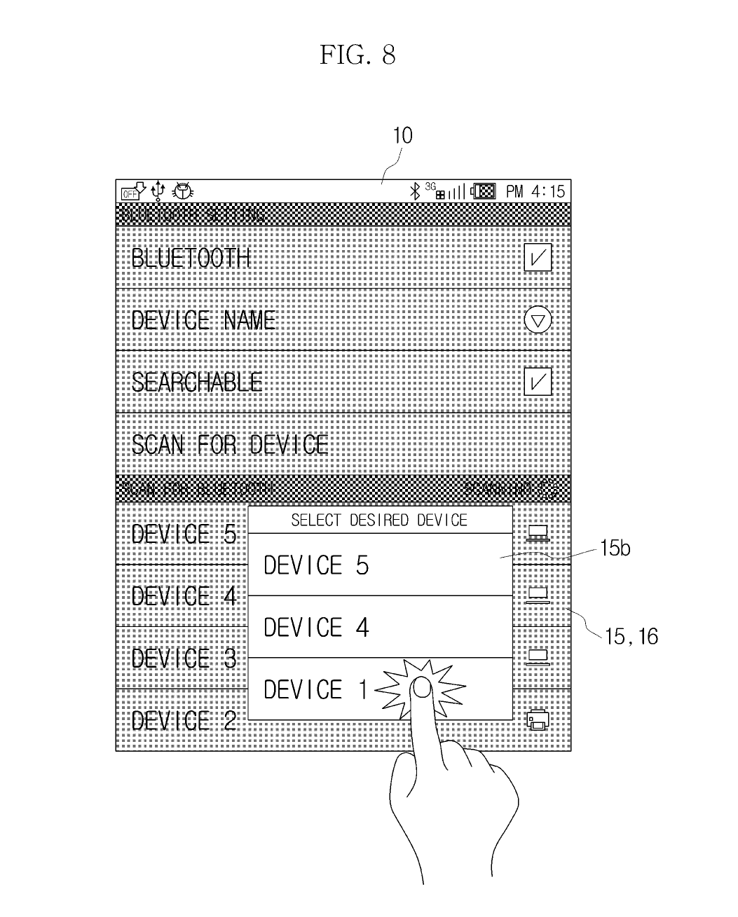

FIGS. 7 and 8 are diagrams illustrating a selection pop-up window in the terminal 10 where there is a user input within a reference time period T after an update of UI information in the terminal 10, in apparatuses and methods for providing a dynamic user interface to provide user input correction of dynamic UI information, according to exemplary embodiments of the present invention.

It may occur that a list is updated while the user tries to touch and select a device 1 with a finger and thus the user touches a device 4. However, according to exemplary embodiments, such occurrence may be reduced when the touch is input to the terminal 10 within the reference time period T after the update time point, as illustrated in FIG. 7. For example, the device 4 and the device 1, as illustrated in FIG. 7, are displayed on a pop-up window 15a, such as on the input unit 15, or when the input unit 15 is combined with the display unit 16, displayed on the display unit 16, for re-selection of the user. When the user touches the device 1, in the pop-up window 15a, an UI information item that is to be originally selected corresponding to device 1 may be selected and UI information corresponding to device 1 may be displayed on the display unit 16 of the terminal 10, according to exemplary embodiments.

Similarly, FIG. 8 illustrates a pop-up window 15b where the list is updated once more before the touch user input to the input unit 15 such that the corresponding position indicates a device 5, and then the user inputs a touch on pop-up window 15b, such as on the input unit 15, or when the input unit 15 is combined with the display unit 16, such as displayed on the display unit 16. Also, in the example illustration of FIG. 8, the touch of the user is made within the reference time period T from the first update, so that all the three pieces of UI information due to the two updates are stored in the storage unit 14. Here, all of the UI information items corresponding to device 5, the device 4, and the device 1 are displayed on the pop-up window 15b for selection of the user. When the user selects the device 1, for example, the UI information item that is to be originally selected corresponding to device 1 may be selected and UI information corresponding to device 1 may be displayed on the display unit 16 of the terminal 10, according to exemplary embodiments. If, however, the user decided to select another UI information item, such as device 5, for example, UI information corresponding to device 5 may be displayed on the display unit 16 of the terminal 10, according to exemplary embodiments.

According to exemplary embodiments, occurrence of errors in a user input to the dynamic UI which is dynamically updated in the terminal may be minimized or reduced by methods and apparatuses described above, and re-selection may be performed immediately or in a relatively short time, and as may be performed without an additional cancelling operation, so that a relatively fast user input operation may be intuitively performed.

Also, the exemplary embodiments according to the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM discs and DVD; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A terminal to provide user input correction of dynamic user interface information, the terminal comprising:
an update determination unit to determine if user interface (UI) information for at least one UI information item is updated;
a storage unit to store the UI information for the at least one UI information item; and
a control unit to control storing of the UI information for the at least one UI information item in the storage unit before an occurrence of an update of the UI information and after the occurrence of the update of the UI information when it is determined the UI information for the at least one UI information item is updated.

2. The terminal of claim 1, further comprising:
a display unit; and
an input unit to detect a user input to the terminal to display the UI information for at least one UI information item,
wherein the control unit controls the display unit to selectively display the stored UI information for the at least one UI information item based upon a time of the user input.

3. The terminal of claim 1, wherein
the control unit determines if a reference time period measured from a time of the occurrence of the update of the UI information has elapsed, and
the control unit deletes the UI information for the at least one UI information item stored in the storage unit before the occurrence of the update of the UI information when the reference time period has elapsed.

4. The terminal of claim 1, wherein:
the update determination unit determines the occurrence of a plurality of updates to the UI information for the at least one UI information item,
the storage unit stores the UI information for the at least one UI information item corresponding to the plurality of updates of the UI information, and
the control unit deletes the UI information for the at least one UI information item stored in the storage unit before the occurrence of a corresponding update of the UI information based upon if a reference time period measured from a time of the occurrence of the corresponding update of the plurality of updates of the UI information has elapsed.

5. The terminal of claim 1, wherein
the control unit controls a display unit to selectively display the stored UI information for the at least one UI information item stored before the occurrence of the update of the UI information and the at least one UI information stored after the occurrence of the update of the UI information when the UI information has been updated based upon if a reference time period measured from the time of the occurrence of the update of the UI information has elapsed.

6. The terminal of claim 1, wherein
the control unit controls deleting the UI information for the at least one UI information item stored in the storage unit before the occurrence of the update of the UI information after a reference time period measured from the time of the occurrence of the update of the UI information has elapsed.

7. The terminal of claim 1, further comprising:
a UI information detection unit to detect received UI information for the at least one UI information item received by the terminal, and
wherein the update determination unit updates the UI information for the at least one UI information item to store in the storage unit, based upon the UI information detected by the UI information detection unit.

8. The terminal of claim 1, further comprising:
a timer unit to receive a time corresponding to the occurrence of the update of the UI information from the update determination unit and to determine if a reference time period measured from a time corresponding to the occurrence of the update of the UI information has elapsed, and
wherein a display of the stored UI information for the at least one UI information item on a display unit is based upon the determined reference time period.

9. The terminal of claim 8, wherein
the control unit deletes the UI information for the at least one UI information item stored in the storage unit before the time of the occurrence of the update of the UI information when the reference time period has elapsed.

10. A method for providing user input correction of dynamic user interface information in a terminal, the method comprising:
determining if user interface (UI) information for at least one UI information item is updated; and
storing the UI information for the at least one UI information item before an occurrence of an update of the UI information and after the occurrence of the update of the UI information, when it is determined the UI information for the at least one UI information item is updated.

11. The method of claim 10, further comprising:
detecting a user input to the terminal to display the UI information for the at least one UI information item, and
displaying the stored UI information for the at least one UI information item based upon a time of the user input.

12. The method of claim 10, further comprising:
deleting the UI information for the at least one UI information item stored before the occurrence of the update of the UI information after a reference time period measured from a time of the occurrence of the update of the UI information has elapsed.

13. The method of claim 10, further comprising:
determining the occurrence of a plurality of updates to the UI information for the at least one UI information item;
storing the UI information for the at least one UI information item corresponding to the plurality of updates of the UI information; and
deleting the UI information for the at least one UI information item stored before the occurrence of a corresponding update when a reference time period measured from a time of the occurrence of the corresponding update of the plurality of updates of the UI information has elapsed.

14. The method of claim 10, further comprising:
detecting received UI information for the at least one UI information item received by the terminal; and
updating the UI information for the at least one UI information item based upon the detected UI information.

15. The method of claim 10, further comprising:
determining a time corresponding to the occurrence of the update of the UI information;
determining a reference time period measured from the time corresponding to the occurrence of the update of the UI information; and
selectively displaying the stored UI information for the at least one UI information item based upon the determined reference time period.

16. The method of claim 15, further comprising:
deleting the UI information for the at least one UI information item stored before the occurrence of the update of the UI information when the reference time period has elapsed.

17. The method of claim 10, further comprising:
determining if a reference time period measured from a time of the occurrence of the update of the UI information has elapsed; and
determining to selectively display the stored UI information for the at least one UI information item based upon the reference time period.

18. The method of claim 17, further comprising:
determining to selectively display the stored UI information for the at least one UI information item based upon a user input being received within the reference time period or after the reference time period has elapsed.

19. The method of claim 17, further comprising:
selectively displaying the stored UI information for the at least one UI information item based upon a user input being received within the reference time period or after the reference time period has elapsed.

20. The method of claim 17, further comprising:
displaying a dynamic UI including UI information for the at least one UI information item.
